(19) United States
(12) Patent Application Publication
(10) Pub. No.: US 2025/0245198 A1
(43) Pub. Date: Jul. 31, 2025

(54) SYSTEM AND METHODS FOR WRITING FILESYSTEM FILE DATA TO NATIVE OBJECTS IN OTHER DATA STORES

(71) Applicant: KOMPRISE, INC., CAMPBELL, CA (US)

(72) Inventors: Jayalakshmi Pattabiraman, Campbell, CA (US); Nahush Bhanage, Campbell, CA (US); Udyavar Suguna Kamath, Campbell, CA (US)

(73) Assignee: KOMPRISE, INC., CAMPBELL, CA (US)

(21) Appl. No.: 19/093,716

(22) Filed: Mar. 28, 2025

Related U.S. Application Data
(60) Provisional application No. 63/626,455, filed on Jan. 29, 2024.

(51) Int. Cl. G06F 16/16

(52) U.S. Cl. CPC G06F 16/16

(57) ABSTRACT

An electronic filesystem has a processor. A memory is coupled to the processor. The memory stores program instructions that, when executed by the processor, causes the processor to: write a file to into the filesystem; and store data of the file as complete native entities in a backing store at a specific mapped location. When a user one of modifies the file or rewrites the file entirely, the filesystem stores new file data in new complete native entities in the backing store.

### RELATED APPLICATIONS

This patent application is related to U.S. Provisional Application No. 63/626,455 filed Jan. 29, 2024, entitled “SYSTEM AND METHODS FOR WRITING FILESYSTEM FILE DATA TO NATIVE OBJECTS IN OTHER DATA STORES”, in the names of the same inventors which is incorporated herein by reference in its entirety. The present patent application claims the benefit under 35 U.S.C § 119 (e) of the aforementioned provisional application.

### BACKGROUND

A filesystem may be a structure that organizes and manages files on a storage device. Filesystems may be used by an operating system to define how data is stored, accessed, and organized. A filesystem that may allow reading and writing files stored on an entirely different data store has previously been invented as described in U.S. Pat. No. 10,198,447, which is hereby incorporated by reference in its entirety. A principal benefit of storing files in a different data store is to be able to access the files from that data store as data native to that data store. As an example, and without loss of generality, a filesystem that exports itself as network file system (NFS) while storing its data in an object store as one object per file can see its data accessed as a file in the filesystem as well as an object in the object store. This native access of stored data as an entity in another form can provide a great benefit in leveraging the data for other uses.

If the only allowed operations performed on the files in the filesystems are reads, the equality of the data of the file in the filesystem and the data of the backing native entity is guaranteed. However, if the filesystem allows writes, the behavior and performance of the backing data store may not permit the writes to be stored in the same single native entity. In particular, object stores do not allow their objects to be modified in place. They must be entirely rewritten. But rewriting entire native entities in the backing data store on every file write may simply take too long for the filesystem protocol and time out the client of the writes. Some other mechanism for writing and storing the newly written data is required.

Hence there is a need for a system and method to allow writes to files stored in filesystems that are backed by equivalent entities in a different data store.

Limitations and disadvantages of conventional and traditional approaches will become apparent to one of skill in the art, through comparison of described method with some aspects of the present disclosure, as set forth in the remainder of the present application and with reference to the drawings.

### SUMMARY

According to an embodiment of the disclosure, an electronic filesystem is provided. The electronic filesystem has a processor. A memory is coupled to the processor. The memory stores program instructions that when executed by the processor, causes the processor to: write a file into the filesystem; and store data of the file as complete native entities in a backing store at a specific mapped location. When a user one of modifies the file or rewrites the file entirely, the filesystem stores new file data in new complete native entities in the backing store.

According to an embodiment of the disclosure, an electronic filesystem is provided. The electronic filesystem has a processor. A memory is coupled to the processor. The memory stores program instructions that when executed by the processor, causes the processor to: write a file into the filesystem; store data of the file as complete native entities in a backing store at a specific mapped location, wherein when a user one of modifies the file or rewrites the file entirely, the filesystem stores new file data in new complete native entities in the backing store; and read byte ranges of the file from respective entities storing a latest version of the byte ranges, wherein byte range information indicates which byte ranges of the file are in what byte ranges of an entity of the file as originally written to the filesystem and which byte ranges of the file are in an entity of a successive write.

The electronic filesystem has a processor. A memory is coupled to the processor. The memory stores program instructions that when executed by the processor, causes the processor to: write a file into the filesystem; store data of the file as complete native entities in a backing store at a specific mapped location wherein when a user one of modifies the file or rewrites the file entirely, the filesystem stores new file data in new complete native entities in the backing store; read byte ranges of the file from respective entities storing a latest version of the byte ranges; stream a complete file serially from all entities storing a latest version of the file; coalesce the file from a plurality of entities to a new single entity, wherein the new single entity is stored in an original location on the backing store so it can be read as an up-to-date native copy of the file originally in the filesystem on the backing store; and collect successive writes to the file through the file system in a buffer to optimize creation of new entities to store the successive writes.

### BRIEF DESCRIPTION OF THE DRAWINGS

FIG. 1 is a diagram of an exemplary electronic filesystem according to one aspect of the present application;

FIG. 2 is a simplified block diagram showing an illustrative computing device/server depicted in FIG. 1, in accordance with one aspect of the present application;

FIG. 3A depicts an exemplary filesystem operation for the electronic filesystem of FIG. 1 in accordance with one aspect of the present application;

FIG. 3B depicts an exemplary filesystem operation for the electronic filesystem of FIG. 1 in accordance with one aspect of the present application;

FIG. 3C depicts an exemplary filesystem operation for the electronic filesystem of FIG. 1 in accordance with one aspect of the present application;

FIG. 3D depicts an exemplary filesystem operation for the electronic filesystem of FIG. 1 in accordance with one aspect of the present application;

FIG. 4 depicts an exemplary filesystem operation for the electronic filesystem of FIG. 1 in accordance with one aspect of the present application;

FIG. 5 depicts an exemplary filesystem operation for the electronic filesystem of FIG. 1 in accordance with one aspect of the present application;

FIG. 6 depicts an exemplary filesystem operation for the electronic filesystem of FIG. 1 in accordance with one aspect of the present application;

FIG. 7 depicts an exemplary filesystem operation for the electronic filesystem of FIG. 1 in accordance with one aspect of the present application; and

FIG. 8 depicts an exemplary filesystem operation for the electronic filesystem of FIG. 1 in accordance with one aspect of the present application.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The detailed description is presented largely in terms of description of shapes, configurations, and/or other symbolic representations that directly or indirectly resemble one or more novel electronic file and management systems and methods of operating such novel systems. These descriptions and representations are the means used by those experienced or skilled in the art to most effectively convey the substance of their work to others skilled in the art.

Reference herein to “one embodiment” or “an embodiment” may mean that a particular feature, structure, or characteristic described in connection with the embodiment can be included in at least one embodiment of the invention. The appearances of the phrase “in one embodiment” in various places in the specification are not necessarily all referring to the same embodiment. Furthermore, separate or alternative embodiments are not necessarily mutually exclusive of other embodiments. Moreover, the order of blocks in process flowcharts or diagrams representing one or more embodiments of the invention do not inherently indicate any particular order nor imply any limitations in the invention.

Moreover, for the purpose of describing the invention, an “electronic system,” a “computing unit,” and/or a “main computing unit” are each defined as electronic-circuit hardware device, such as a computer system, a computer server, a data storage unit, or another electronic-circuit hardware unit controlled, managed, and maintained by a file migration module, which is executed in a CPU and a memory unit of the electronic-circuit hardware device for the electronic file migration management.

In addition, for the purpose of describing the invention, a term “computer server” is defined as a physical computer system, another hardware device, a software and/or hardware module executed in an electronic device, or a combination thereof. For example, in context of an embodiment of the invention, a “computer server” is dedicated to executing one or more computer programs for executing and maintaining a robust and efficient file and object management system among varieties of storage systems. Furthermore, in one embodiment of the invention, a computer server is connected to one or more data networks, such as a local area network (LAN), a wide area network (WAN), a cellular network, and the Internet.

Embodiments of the exemplary system and method may enable data written to files in a filesystem backed by a different storage to be written to the native entities of the backing storage and then put back together by the filesystem when the file is read back through the filesystem.

A filesystem implemented over a backing store in the style of U.S. Pat. No. 10,198,447 can store a file in the backing store as a complete entity containing the file data in the native form of the backing store. That paradigm allows access of the data through the backing store's native interface, which leverages the data for further uses and makes the filesystem more valuable to the end user. The present system and method may allow the filesystem file data of a file to be stored in an entire entity native to the backing store while writes to the file in the filesystem are stored in other entities in the backing store. The present system and method may retain what parts of a file in the filesystem are stored in what parts of each of the original entity and newly written entities. The present system and method may furthermore provide high performance by collecting multiple writes to a file into a single new entity written to the backing store, and it may provide reliability by guaranteeing that those file writes are stored in multiple places while they are being collected. Finally, the present system and method may coalesce the original native entity of the original file and the newly written entities of the modified file back into a single native entity that again is exactly equal to the file content.

Without loss of generality, the entities that store the file before writes may be performed to the file and store the new written entities may be referred to herein as objects. Also, without loss of generality, they may be referred to as objects stored in an object store. As an alternative example, it is also possible that they are files in a secondary filesystem.

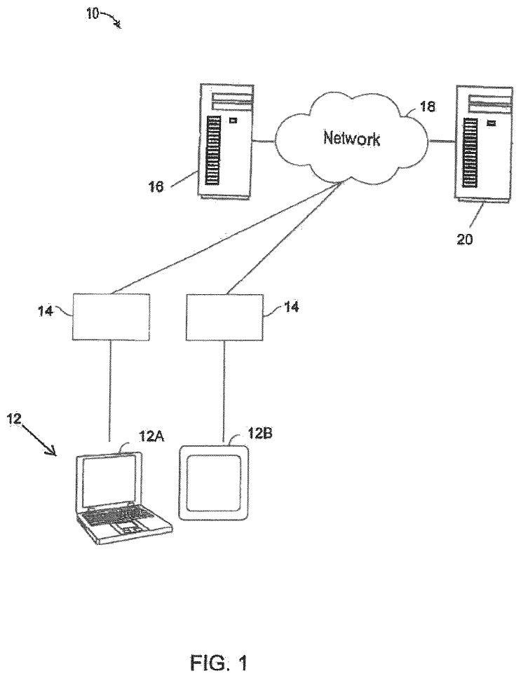

Referring to FIG. 1, an electronic filesystem 10 (hereinafter system 10) may be seen. The components of the system 10 may be coupled through wired or wireless connections.

The system 10 may have one or more computing devices 12. The computing devices 12 may be a client computer system such as a desktop computer, handheld or laptop device, tablet, mobile phone device, server computer system, multiprocessor system, microprocessor-based system, network PCs, and distributed cloud computing environments that include any of the above systems or devices, and the like. The computing device 12 may be described in the general context of computer system executable instructions, such as program modules, being executed by a computer system as may be described below. In the embodiment shown in FIG. 1, the computing device 12 may be seen as a desktop/laptop computing system 12A and a tablet device 12B. However, this should not be seen in a limiting manner as any computing device 12 described above may be used.

The computing devices 12 may be loaded with an operating system 14. The operating system 14 of the computing device 12 may manage hardware and software resources of the computing device 12 and provide common services for computer programs running on the computing device 12.

The computing devices 12 may be coupled to a server 16. The server 16 may be used to store data files, programs, and the like for use by the computing devices 12. The computing devices 12 may be connected to the server 16 through a network 18. The network 18 may be a local area network (LAN), a general wide area network (WAN), wireless local area network (WLAN) and/or a public network.

The system may have one or more servers 20. The servers 20 may be coupled to the server 16 and/or the computing devices 12 through the network 18. The network 18 may be a local area network (LAN), a general wide area network (WAN), wireless local area network (WLAN) and/or a public network.

The servers 20 may be used for migration and data back-up. The server 20 may be any data storage devices/system. In accordance with one embodiment, the server 20 may be cloud data storage. Cloud data storage is a model of data storage in which the digital data is stored in logical pools, the physical storage may span multiple servers (and often locations), and the physical environment is typically owned and managed by a third-party hosting company. However, as defined above, cloud data storage may be any type of data storage device/system.

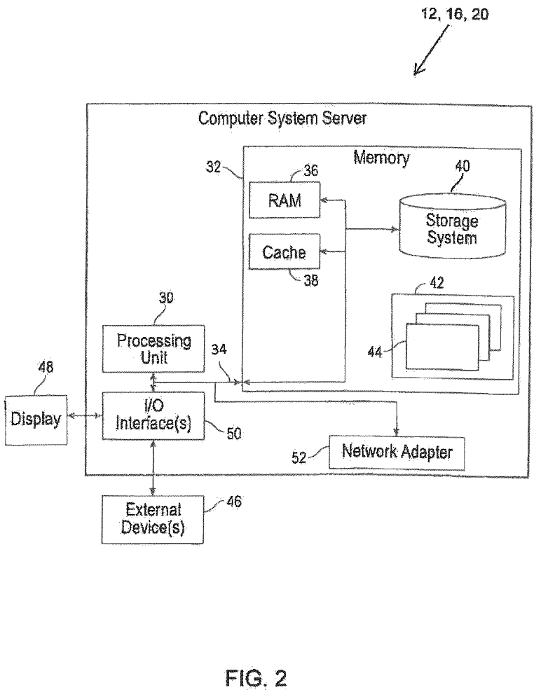

Referring now to FIG. 2, the computing devices 12 and/or servers 16, 20 may be described in more detail in terms of the machine elements that provide functionality to the systems and methods disclosed herein. The components of the computing devices 12 and/or servers 16, 20 may include, but are not limited to, one or more processors or processing units 30, a system memory 32, and a system bus 34 that couples various system components including the system memory 32 to the processor 30. The computing devices 12 and/or servers 16, 20 may typically include a variety of computer system readable media. Such media may be chosen from any available media, including non-transitory, volatile and non-volatile media, removable and non-removable media. The system memory 32 could include one or more personal computing system readable media in the form of volatile memory, such as a random-access memory (RAM) 36 and/or a cache memory 38. By way of example only, a storage system 40 may be provided for reading from and writing to a non-removable, non-volatile magnetic media device typically called a “hard drive”.

The system memory 32 may include at least one program product/utility 42 having a set (e.g., at least one) of program modules 44 that may be configured to carry out the functions of embodiments of the invention. The program modules 44 may include, but is not limited to, an operating system, one or more application programs, other program modules, and program data. Each of the operating systems, one or more application programs, other program modules, and program data or some combination thereof, may include an implementation of a networking environment. The program modules 44 generally carry out the functions and/or methodologies of embodiments of the invention as described herein.

The computing device 12 and/or servers 16, 20 may communicate with one or more external devices 46 such as a keyboard, a pointing device, a display 48, or any similar devices (e.g., network card, modern, etc.). The display 48 may be a Light Emitting Diode (LED) display, Liquid Crystal Display (LCD) display, Cathode Ray Tube (CRT) display and similar display devices. The external devices 46 may enable the computing devices 12 and/or servers 16, 20 to communicate with other devices. Such communication may occur via Input/Output (I/O) interfaces 50. Alternatively, the computing devices and/or servers 18, 20 may communicate with one or more networks 18 such as a local area network (LAN), a general wide area network (WAN), and/or a public network via a network adapter 52. As depicted, the network adapter 52 may communicate with the other components of the computing device 18 via the bus 34.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, microcode, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any combination of one or more computer readable media (for example, storage system 40) may be utilized. In the context of this disclosure, a computer readable storage medium may be any tangible or non-transitory medium that can contain, or store a program (for example, the program product 42) for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

The description below may provide example embodiments in detail. It does not, and is not meant to, limit the invention's application to those details. For instance, files can mean files or objects; filesystems can mean shares, fileservers, clusters, or object stores; etc.

### Example 1

Referring to FIGS. 1-3, one example of the operation of the system 10 may be disclosed. The system 10 may implement a filesystem accessed by clients. The filesystem may be implemented on computing devices 12 and/or servers 16, 20. In accordance with an embodiment, the system 10 may be implemented on a cloud data storage housed in the server 20.

When those clients write new files to the server 20 implementing the filesystem, the server 20 may store them as complete native entities in another storage that stores the data behind the filesystem. When clients modify or rewrite entire files, the server 20 implementing the filesystem may store the new file data in new complete native entities in the backing storage. But when clients modify byte ranges of those files, the server 20 implementing the filesystem may store the newly modified parts of those files in incomplete native entities in the backing storage and may record the byte ranges stored in each native entity in the filesystem metadata for each file.

A specific example of a filesystem backed by an object store can elucidate the embodiment. The details of the example should not be seen as limiting the invention or the embodiment to those details.

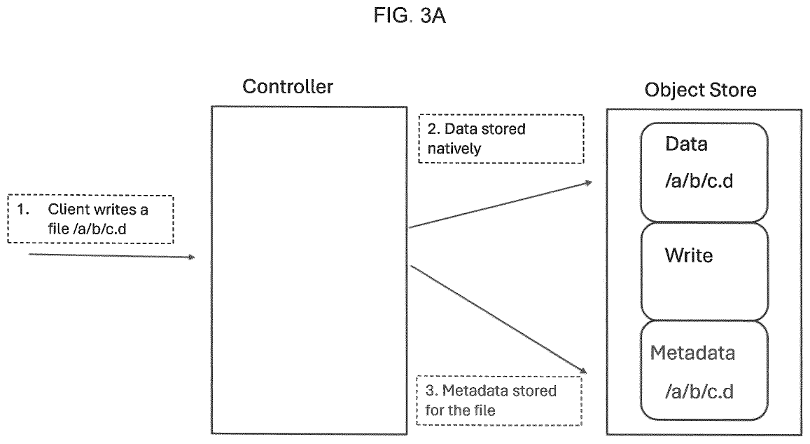

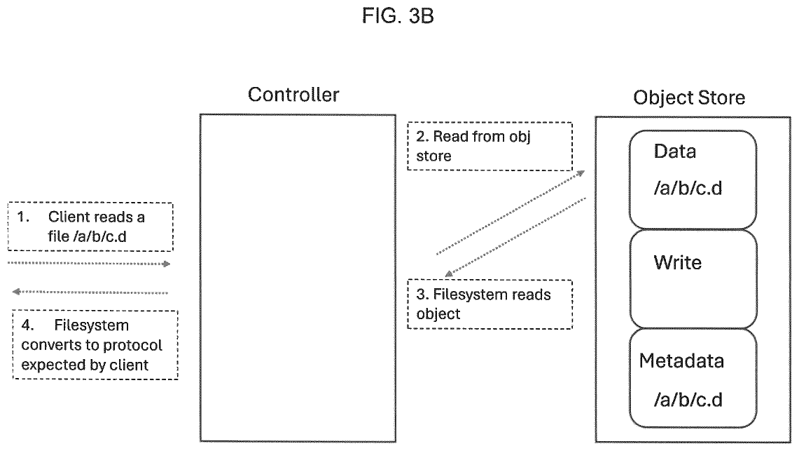

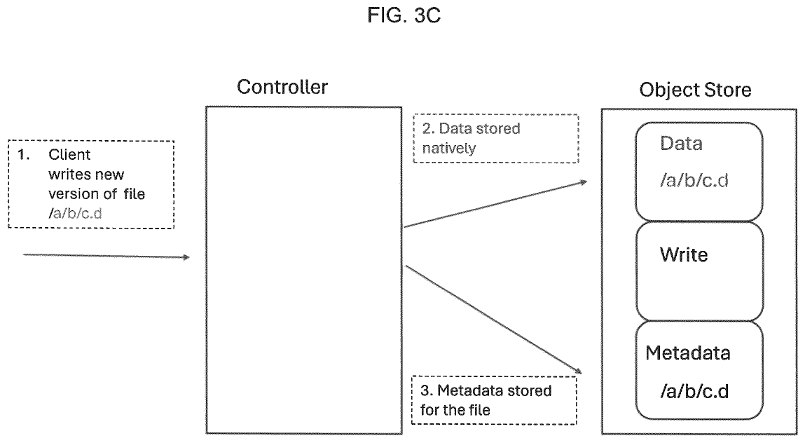

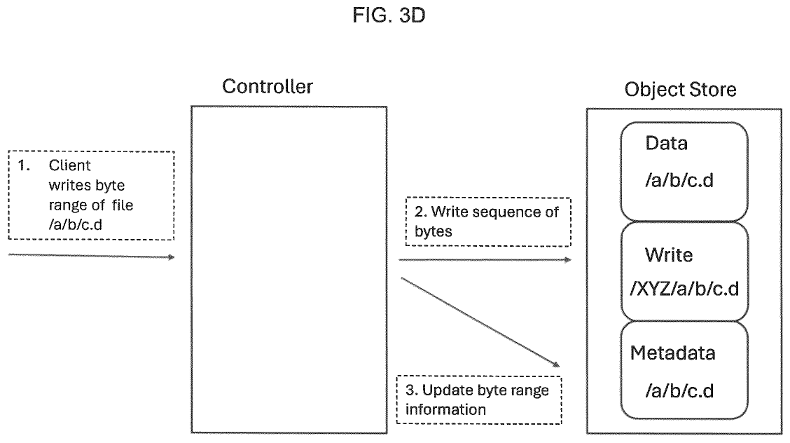

In this example shown in FIG. 3A, a client may write a new file /a/b/c.d into the filesystem. The data of that file may be stored natively in an object in the object store under the object key /data/a/b/c.d. The filesystem client may read the file content through the filesystem by reading /a/b/c.d, and the filesystem may read the object from /data/a/b/c.d and express it through the filesystem, converting it to the filesystem protocol expected by the client as may be shown in FIGS. 3B-3C. An object store client may also read the file content directly from the object /data/a/b/c.d.

When the client writes a new version of the file /a/b/c.d as shown in FIG. 3D, possibly by outright copying another file, the filesystem replaces the object /data/a/b/c.d in the backing object store with the new file content.

However, if the client writes a byte range—a sequence of bytes—through the filesystem in the middle of file /a/b/c.d as may be shown in FIG. 3E, this embodiment of the invention may write that sequence of bytes in another object, such as /write/XYZ/a/b/c.d, storing in the filesystem metadata for file /a/b/c.d the byte range information recording the new write. That byte range information will carry which byte ranges of the file /a/b/c.d are in what byte ranges of the original object /data/a/b/c.d and which byte ranges of the file /a/b/c.d are in the new write object /write/XYZ/a/b/c.d.

Further writes to the file would generate new write objects in the object store, again preserving which byte ranges of the file are stored in which byte ranges of the new write objects and which byte ranges of the file are stored in which byte ranges of the old write objects and the original data object.

Note that an object store client reading the original file from the object store may find /data/a/b/c.d still retains the originally written file data before any modifications to it were made.

### Example 2

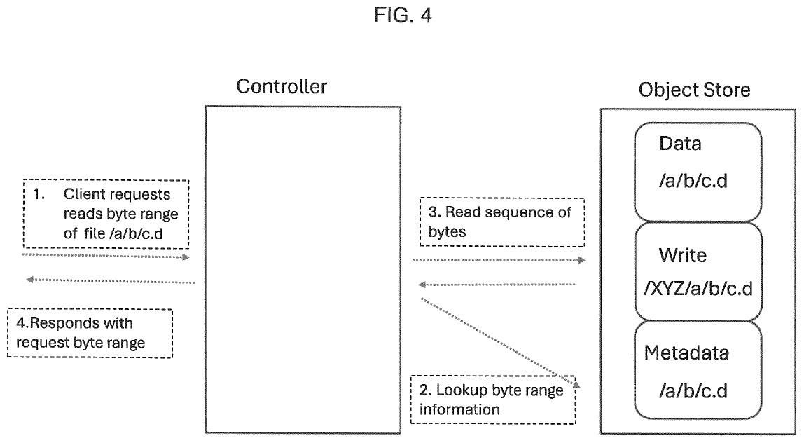

Referring to FIG. 4, in this example, the machine implementing the filesystem accessed by clients of the filesystem may recognize the byte ranges of the file being requested in a file read request, look up the byte ranges in the filesystem metadata for the file as stored in the backing store, read the particular entities in the backing store and what byte ranges of those entities store the byte ranges of the requested file, and responds to the file read request with the requested byte ranges pieced together from the corresponding byte ranges of the entities in the backing store storing the parts of the file.

### Example 3

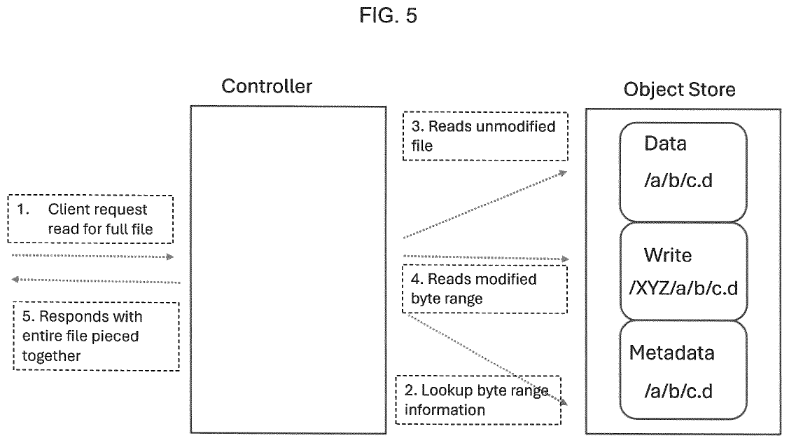

In another example as may be shown in FIG. 5, the machine implementing the filesystem accessed by clients of the filesystem may accept a request for a full file read, looks up the byte ranges in the filesystem metadata for the file as stored in the backing store, reads the particular entities in the backing store and what byte ranges of those entities store the byte ranges of the requested file, and responds to the file read request with the entire file data from beginning to end pieced together from the corresponding byte ranges of the entities in the backing store storing the parts of the file.

### Example 4

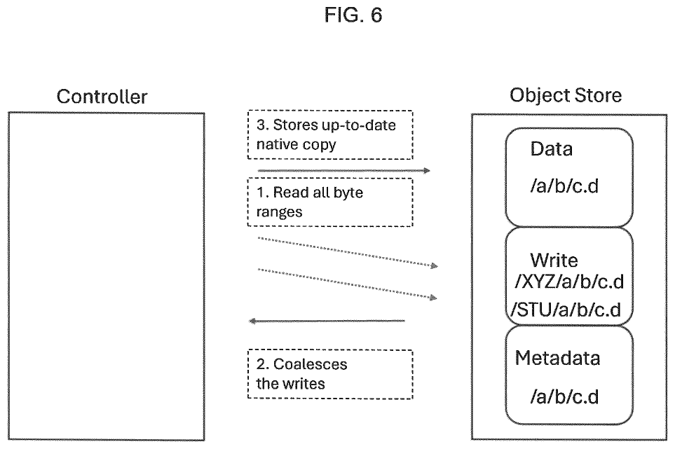

In another example as may be shown in FIG. 6, the machine implementing the filesystem coalesces the original entity storing a file in the filesystem's original file data and all the newly written entities for the file data in the backing store in a similar fashion as Embodiment 3 and stores the resulting file data in a single native entity that again equals the file data of the file in the filesystem. This single entity may again be stored in the original location on the backing store so it may again be read as the up-to-date native copy of the original file in the filesystem on the backing store.

This embodiment may bring the entities on the backing store back to being the native copies on the backing store of the files in the file system that may enable their use by direct access as native entities through the backing store's interface.

### Example 5

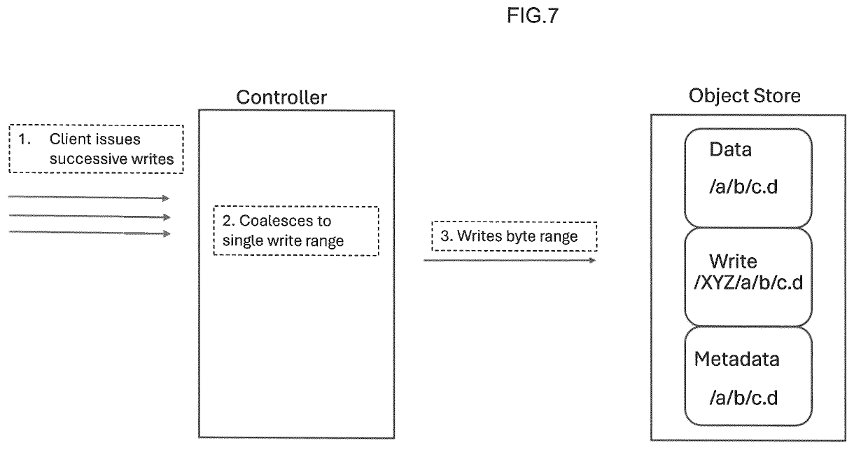

In another example of the invention as may be shown in FIG. 7, the machine implementing the filesystem may collect successive writes to a file through the filesystem in a buffer in memory or on disk. Periodically those multiple file writes may be coalesced and written as a set of byte ranges of the file data to a single new entity in the backing store. This example may implement that periodic coalescing based on total time passed, based on a count of writes, based on a count of the total size of the writes, based on a duration of time since the last write, or based on another mechanism.

This example may result in many fewer writes to the backing store, many fewer write entities present in the backing store, and many fewer byte ranges to track in the filesystem file metadata, all of which improve write and read performance.

### Example 6

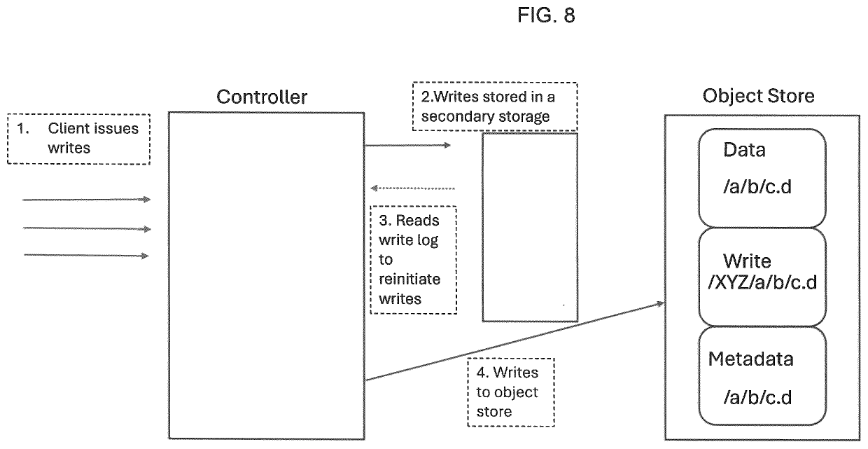

In another example of the invention as may be shown in FIG. 8, the collected writes to a file in the filesystem that are kept in memory or disk may also be retained in a write log in a secondary storage. In the event of failure or restart of the filesystem, the filesystem reads the write log to reinitiate and continue in-flight writes of the file to the filesystem as stored in the backing store. Writes to the filesystem of the file metadata may be similarly retained in the write log in the secondary storage.

This embodiment may allow the rapid acknowledgement of write requests to the filesystem protocol so the filesystem client can continue knowing the write request was handled while maintaining filesystem reliability in the presence of failures, restarts, or other unforeseen events.

While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure not to be limited to the embodiment disclosed, but that the present disclosure will include all embodiments that fall within the scope of the appended claims.

1. An electronic filesystem comprising:
a processor;
a memory coupled to the processor, the memory storing program instructions that when executed by the processor, causes the processor to:
write a file into the filesystem; and
store data of the file as complete native entities in a backing store at a specific mapped location;
wherein when a user one of modifies the file or rewrites the file entirely, the filesystem stores new file data in new complete native entities in the backing store.

2. The electric filesystem of claim 1, wherein the memory storing program instructions that when executed by the processor, causes the processor to read byte ranges of the file from respective entities storing a latest version of the byte ranges.

3. The electric filesystem of claim 1, wherein the memory storing program instructions that when executed by the processor, causes the processor to:
perform a first write on a byte range of the file through the filesystem, the first write changing a sequence of bytes in the file;
write and store the sequence of bytes in another entity in the backing store;
store in metadata of the filesystem for the file byte range information recording the first write.

4. The electric filesystem of claim 3, wherein the byte range information indicates which byte ranges of the file are in what byte ranges of an entity of the file as originally written to the filesystem and which byte ranges of the file are in an entity of the first write.

5. The electric filesystem of claim 4, wherein the memory storing program instructions that when executed by the processor, causes the processor to:
generate new entities for each proceeding new write,
write and store each corresponding new entity in the backing store; and
store in metadata of the filesystem for each corresponding file byte range information recording each proceeding new write, wherein each corresponding file byte range information indicates which byte ranges of the file are in what byte ranges of an entity of the file as originally written to the filesystem and which byte ranges of the file are in an entity of each proceeding new write.

6. The electric filesystem of claim 1, wherein the memory storing program instructions that when executed by the processor, causes the processor to stream a complete file serially from all entities storing a latest version of the file.

7. The electric filesystem of claim 5, wherein the memory storing program instructions that when executed by the processor, causes the processor to:
receive a file read;
look-up byte ranges in the metadata of the filesystem as stored in the backing store;
read entities in the backing store corresponding to corresponding byte range information of a requested file of the file read; and
sending the byte ranges requested.

8. The electric filesystem of claim 1, wherein the memory storing program instructions that when executed by the processor, causes the processor to coalesce the file from a plurality of entities to a new single entity.

9. The electric filesystem of claim 8, wherein the new single entity is stored in an original location on the backing store so it can be read as an up-to-date native copy of the file originally in the filesystem on the backing store.

10. The electric filesystem of claim 1, wherein the memory storing program instructions that when executed by the processor, causes the processor to collect successive writes to the file through the file system in a buffer to optimize creation of new entities to store the successive writes.

11. The electric filesystem of claim 1, wherein the memory storing program instructions that when executed by the processor, causes the processor to write a log in a secondary storage collected writes to the file in the filesystem.

12. An electronic filesystem comprising:
a processor;
a memory coupled to the processor, the memory storing program instructions that when executed by the processor, causes the processor to:
write a file into the filesystem;
store data of the file as complete native entities in a backing store at a specific mapped location, wherein when a user one of modifies the file or rewrites the file entirely, the filesystem stores new file data in new complete native entities in the backing store; and
read byte ranges of the file from respective entities storing a latest version of the byte ranges, wherein byte range information indicates which byte ranges of the file are in what byte ranges of an entity of the file as originally written to the filesystem and which byte ranges of the file are in an entity of a successive write.

13. The electric filesystem of claim 12, wherein the memory storing program instructions that when executed by the processor, causes the processor to stream a complete file serially from all entities storing a latest version of the file.

14. The electric filesystem of claim 12, wherein the memory storing program instructions that when executed by the processor, causes the processor to:
receive a file read;
look-up byte ranges in the metadata of the filesystem as stored in the backing store;
read entities in the backing store corresponding to corresponding byte range information of a requested file of the file read; and
sending the byte ranges requested.

15. The electric filesystem of claim 12, wherein the memory storing program instructions that when executed by the processor, causes the processor to coalesce the file from a plurality of entities to a new single object.

16. The electric filesystem of claim 15, wherein the new single entity is stored in an original location on the backing store so it can be read as an up-to-date native copy of the file originally in the filesystem on the backing store.

17. The electric filesystem of claim 12, wherein the memory storing program instructions that when executed by the processor, causes the processor to collect successive writes to the file through the file system in a buffer to optimize creation of new entities to store the successive writes.

18. The electric filesystem of claim 12, wherein the memory storing program instructions that when executed by the processor, causes the processor to write a log in a secondary storage of collected writes to the file in the filesystem.

19. An electronic filesystem comprising:
a processor;
a memory coupled to the processor, the memory storing program instructions that when executed by the processor, causes the processor to:
write a file into the filesystem;
store data of the file as complete native entities in a backing store at a specific mapped location wherein when a user one of modifies the file or rewrites the file entirely, the filesystem stores new file data in new complete native entities in the backing store;
read byte ranges of the file from respective entities storing a latest version of the byte ranges;
stream a complete file serially from all entities storing a latest version of the file;
coalesce the file from a plurality of entities to a new single entity, wherein the new single entity is stored in an original location on the backing store so it can be read as an up-to-date native copy of the file originally in the filesystem on the backing store; and
collect successive writes to the file through the file system in a buffer to optimize creation of new entities to store the successive writes.

20. The electric filesystem of claim 19, wherein the memory storing program instructions that when executed by the processor, causes the processor to write a log in a secondary storage of collected writes to the file in the filesystem.
